(19) United States
(12) Patent Application Publication
(10) Pub. No.: US 2023/0162142 A1
(43) Pub. Date: May 25, 2023

(54) METHOD AND SYSTEM FOR PRODUCT SOURCING

(71) Applicant: INFOSYS LIMITED, Bangalore (IN)

(72) Inventors: Majush Koshy PHILIP, Kollam District (IN); Divyesh Hasmukhrai PAREKH, Thergaon (IN); Kiran Sharadchandra MANDREKAR, Katy, TX (US)

(21) Appl. No.: 17/692,285

(22) Filed: Mar. 11, 2022

(30) Foreign Application Priority Data
Nov. 24, 2021 (IN) 202141054167

(51) Int. Cl. G06Q 10/08; G06Q 30/02

(52) U.S. Cl. CPC G06Q 10/087; G06Q 10/083; G06Q 30/0283

(57) ABSTRACT

Disclosed is a method and system for optimal product sourcing. For each combination of the products requested in an order, and for each fulfilling location, the value of multiple parameters is calculated. Ranking of each parameter is also used while calculating the values. The calculated values along with the combinations of products and the fulfilling locations are provided to an optimization engine, and an optimal sourcing option is received as an output.

This application claims the benefit of Indian Patent Application Serial No. 202141054167, filed Nov. 24, 2021, which is hereby incorporated by reference in its entirety.

### FIELD

The disclosure generally relates to product sourcing, and more particularly to intelligent sourcing of products.

### BACKGROUND

Conventionally orders for any product are fulfilled from dedicated centers, or it is based on some rules such as nearest location, or lowest cost or some combination etc. While product ordering platforms have advanced and developed at a high pace, delivery and other fulfillment operations are yet to improvise so that the experience as a whole is smoother and more effective.

### SUMMARY

This disclosure provides an embodiment of a method for product sourcing. The method involves fetching one or more fulfilling locations for each combination of one or more products required at a ship-to location, verifying if one or more delivery locations associated with the fetched fulfilling locations, include the ship-to location for each of the combination. It further involves calculating values for one or more parameters associated with each verified fulfilling location, and each of the parameters is either a positive impact parameter, or a negative impact parameter, & calculating a net benefit cost for each of the combination and each verified fulfilling location using the calculated values of the parameter. An optimal combination of products is identified for the sourcing, from each of the combinations of products, based on one or more of, the net benefit cost and one or more constraints for the products.

This disclosure provides an embodiment of a system for product sourcing comprising a processor and a memory comprising instructions executable by the processor to cause the system to perform operations involving fetching one or more fulfilling locations for each combination of one or more products required at a ship-to location, verifying if one or more delivery locations associated with the fetched fulfilling locations, include the ship-to location for each of the combination. It further includes operations comprising calculating values for one or more parameters associated with each verified fulfilling location, and each of the parameters being one of a positive impact parameter, or a negative impact parameter; calculating a net benefit cost for each of the combination and each verified fulfilling location, using the calculated values of the parameter; and then identifying an optimal combination of products for sourcing, from each of the combinations of products, based on the net benefit cost and one or more constraints for the products.

Provided is an embodiment for a non-transitory computer readable medium with instructions stored thereon that, when executed by a processor, cause the processor to perform operations that comprises fetching one or more fulfilling locations for each combination of one or more products required at a ship-to location (303); verifying if one or more delivery locations associated with the fetched fulfilling locations, include the ship-to location for each of the combination (303); calculating values for one or more parameters associated with each verified fulfilling location, and each of the parameters being one of a positive impact parameter, or a negative impact parameter (303); calculating a net benefit cost for each of the combination and each verified fulfilling location, using the calculated values of the parameter (303); and identifying an optimal combination of products for sourcing, from each of the combinations of products, based on one or more of, the net benefit cost and one or more constraints for the products (303).

### BRIEF DESCRIPION

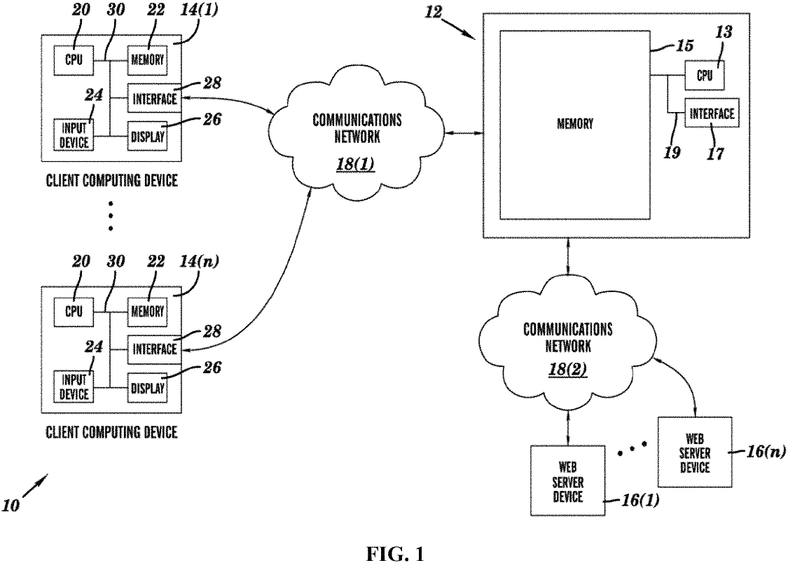

FIG. 1 describes an exemplary computing environment for implementing an embodiment of an ordering platform as disclosed;

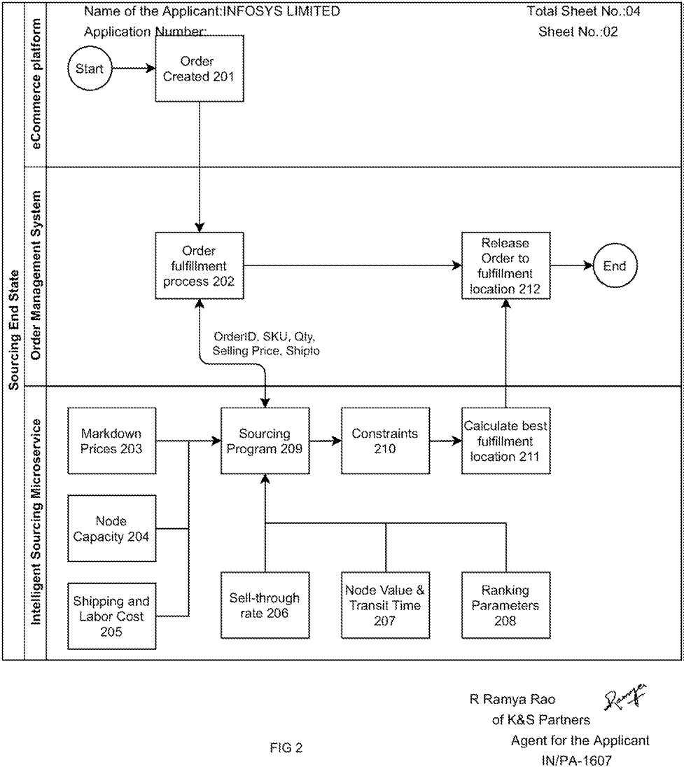

FIG. 2 describes an exemplary process for describing an embodiment for implementing the ordering platform as disclosed;

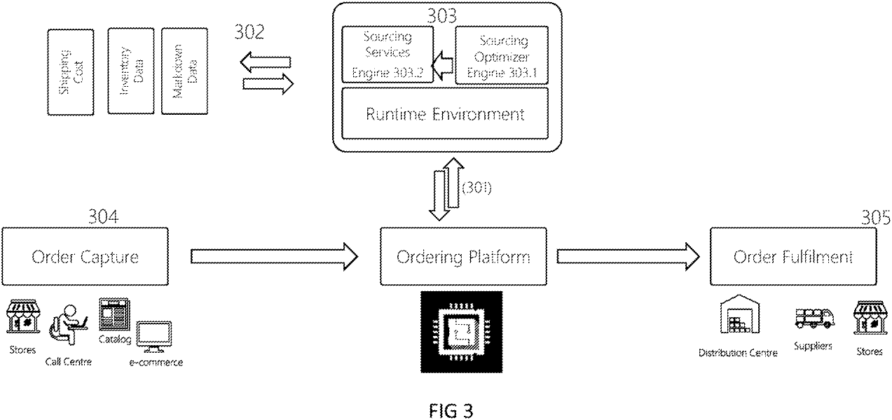

FIG. 3 describes an exemplary integration of an exemplary sourcing system with an ordering platform as disclosed; and

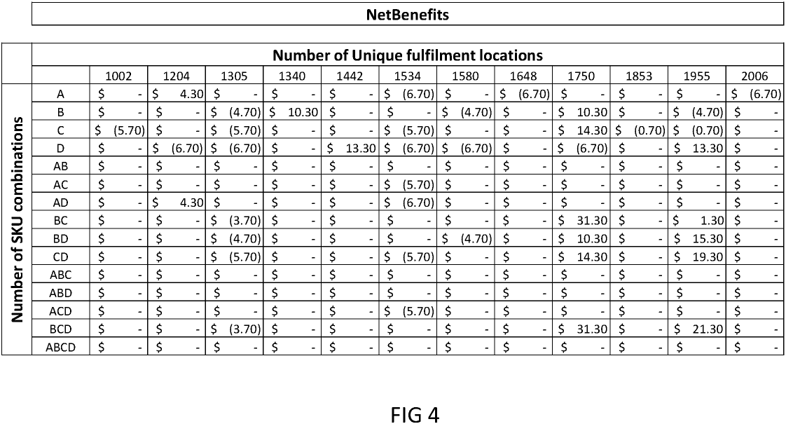

FIG. 4 describes an exemplary process of order sourcing using an example.

### DESCRIPTION

In an embodiment the present disclosure provides intelligent product sourcing from an order placed by a customer. The customer may have placed the order through an eCommerce platform, or from an offline store providing product delivery at a later date.

In an embodiment the present disclosure may use multiple inputs, for instance markdown price of products across the network of store nodes, inventory availability across the network, capacity to fulfil an order or a product from the order, sell through rate, shipping cost from network of store nodes to any customer node in the network, labor cost of the processing, and many more appropriate parameters to optimize sourcing in a dynamic way to fulfill an order in an effective and optimal manner. In an embodiment store may imply any warehouse, any third-party logistics, or supplier fulfilment location. This also enables any ordering platform to adapt to its changing environment by managing the rules dynamically and use fulfillment as a competitive advantage.

An exemplary environment 10 with an ordering platform 12 configured to optimize the product sourcing is illustrated in FIG. 1, although this technology can be implemented on other types of devices, such as one of the web server devices 16(1)-16(n), or any other server computing apparatus configured to receive and process hypertext transfer protocol (HTTP) requests, by way of example only. The exemplary environment 10 includes an ordering platform 12, client devices 14(1)-14(n), the web server devices 16(1)-16(n), and communication networks 18(1)-18(2), although other numbers and types of systems, devices, and/or elements in other configurations and environments with other communication network topologies can be used. This technology provides several advantages including providing a method, computer readable medium and an apparatus that can provide optimal product sourcing while place an order.

Referring more specifically to FIG. 1, the ordering platform 12 may include a central processing unit (CPU) or processor 13, a memory 15, and an interface system 17 which are coupled together by a bus 19 or other link, although other numbers and types of components, parts, devices, systems, and elements in other configurations and locations can be used. The processor 13 in the ordering platform 12 executes a program of stored instructions for one or more aspects of the present disclosure as described and illustrated by way of the embodiments herein, although the processor could execute other numbers and types of programmed instructions.

The memory 15 in the ordering platform 12 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor 13, can be used for the memory 15 in the web content optimization computing apparatus 12.

The interface system 17 in the ordering platform 12 is used to operatively couple and communicate between the ordering platform 12 and the client devices 14(1)-14(n) and the web server devices 16(1)-16(n) via the communication networks 18(1) and 18(2), although other types and numbers of communication networks with other types and numbers of connections and configurations can be used. By way of example only, the communication networks 18(1) and 18(2) can use TCP/IP over Ethernet and industry-standard protocols, including HTTP, HTTPS, WAP, and SOAP, although other types and numbers of communication networks, such as a direct connection, a local area network, a wide area network, modems and phone lines, e-mail, and wireless and hardwire communication technology, each having their own communications protocols, can be used.

Each of the client devices 14(1)-14(n) enables a user to request, receive, and interact with web pages from one or more web sites hosted by the web server devices 16(1)-16(n) through the ordering platform 12 via one or more communication networks 18(1). Although multiple client devices 14(1)-14(n) are shown, other numbers and types of user computing systems could be used. In one example, the client devices 14(1)-14(n) comprise smart phones, kiosks, personal digital assistants, computers, or mobile devices with Internet access that permit a website form page or other retrieved web content to be displayed on the client devices 14(1)-14(n).

Each of the client devices 14(1)-14(n) in this example is a computing device that includes a central processing unit (CPU) or processor 20, a memory 22, user input device 24, a display 26, and an interface system 28, which are coupled together by a bus 30 or other link, although one or more of the client devices 14(1)-14(n) can include other numbers and types of components, parts, devices, systems, and elements in other configurations. The processor 20 in each of the client devices 14(1)-14(n) executes a program of stored instructions for one or more aspects of the present invention as described and illustrated herein, although the processor could execute other numbers and types of programmed instructions.

The memory 22 in each of the client devices 14(1)-14(n) stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to processor 20 can be used for the memory 22 in each of the client devices 14(1)-14(n).

The user input device 24 in each of the client devices 14(1)-14(n) is used to input selections, such as requests for a particular website form page or to enter data in fields of a form page, although the user input device could be used to input other types of data and interact with other elements. The user input device can include keypads, touch screens, and/or vocal input processing systems, although other types and numbers of user input devices can be used.

The display 26 in each of the client devices 14(1)-14(n) is used to show data and information to the user, such as website or application page by way of example only. The display in each of the client devices 14(1)-14(n) can be a mobile phone screen display, although other types and numbers of displays could be used depending on the particular type of client device 14(1)-14(n).

The interface system 28 in each of the client devices 14(1)-14(n) is used to operatively couple and communicate between the client devices 14(1)-14(n), the ordering platform 12, and the web server devices 16(1)-16(n) over the communication networks 18(1) and 18(2), although other types and numbers of communication networks with other types and numbers of connections and configurations can be used.

The web server devices 16(1)-16(n) provide web content such as one or more pages from one or more web sites for use by one or more of the client devices 14(1)-14(n) via the web content optimization computing apparatus 12, although the web server devices 16(1)-16(n) can provide other numbers and types of applications and/or content and can provide other numbers and types of functions. Although the web server devices 16(1)-16(n) are shown for ease of illustration and discussion, other numbers and types of web server systems and devices can be used.

Each of the web server devices 16(1)-16(n) include a central processing unit (CPU) or processor, a memory, and an interface system which are coupled together by a bus or other link, although each of the web server devices 16(1)-16(n) could have other numbers and types of components, parts, devices, systems, and elements in other configurations and locations. The processor in each of the web server devices 16(1)-16(n) executes a program of stored instructions one or more aspects of the present invention as described and illustrated by way of the embodiments herein, although the processor could execute other numbers and types of programmed instructions.

The memory in each of the web server devices 16(1)-16(n) stores these programmed instructions for one or more aspects of the present invention as described and illustrated by way of the embodiments described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory in each of the web server devices 16(1)-16(n).

The interface system in each of the web server devices 16(1)-16(n) is used to operatively couple and communicate between the web server devices 16(1)-16(n), the ordering platform 12, and the client devices 14(1)-14(n) via the communication networks 18(1) and 18(2), although other types and numbers of communication networks with other types and numbers of connections and configurations can be used.

Although embodiments of the ordering platform 12, the client devices 14(1)-14(n), and the web server devices 16(1)-16(n), are described and illustrated herein, each of the client devices 14(1)-14(n), the ordering platform 12, and the web server devices 16(1)-16(n), can be implemented on any suitable computer system or computing device. It is to be understood that the devices and systems of the embodiments described herein are for exemplary purposes, as many variations of the specific hardware and software used to implement the embodiments are possible, as will be appreciated by those skilled in the relevant art(s).

Furthermore, each of the systems of the embodiments may be conveniently implemented using one or more general purpose computer systems, microprocessors, digital signal processors, and micro-controllers, programmed according to the teachings of the embodiments, as described and illustrated herein, and as will be appreciated by those ordinary skill in the art.

In addition, two or more computing systems or devices can be substituted for any one of the systems in any of the embodiments. Accordingly, principles and advantages of distributed processing, such as redundancy and replication also can be implemented, as desired, to increase the robustness and performance of the devices and systems of the embodiments. The embodiments may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The embodiments may also be embodied as a non-transitory computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein.

An exemplary embodiment of the process for implementing product sourcing will now be explained along with the description of FIG. 2. For the purpose of this document, following understanding has been used for the listed terms -

Ship-to location is the location where a user may want one or more of his products to be delivered. Each product in an order, can have a separate ship-to location.

Fulfilling location for a product is the ship-from location, from the where the product will be shipped or sourced. Each product in an order, can have a separate ship-from location. Fulfilling location and ship-from location have been used interchangeably in this document. A fulfilling location may include stores, warehouse, 3 party logistics, supplier fulfilment locations and similar such location.

Delivery network for each fulfilling location implies one or more locations where the products from that fulfilling location can be delivered. One fulfilling location can have one or more delivery network, where it can deliver the products.

Markdown benefits occurs when a product in an order cannot be provided at its current value. By reducing the value, a markdown makes the product more desirable for customers and temporarily increases demand for any low-demand products for sell through all stock.

Sell-through rate estimates a proportion of products provided by a store node, and the products provided to a store node.

Available capacity to fulfil, for each store node, provides the number of shipments a fulfilling location node can provide.

Transit Time is the time required from a fulfilling location to a customer.

Shipping cost is the total cost of shipping between a store node and a customer node.

Labor Cost relates to the cost of processing an order. It may include packing charges, loading charges, picking charges and other such charges.

Node value- Node value may represent the priority or weightage given to locations while evaluating multiple other parameters.

In one embodiment, each of the above listed parameters and other appropriate parameters may be ranked as per the requirement of a user. A user may give higher ranking to markdown value and a lower ranking to transit value. Another user may rank transit value, labor value and shipping cost equally. Against each rank there may be allocated an index value. The index value may be used appropriately to identify the value for each of the above parameters.

FIG. 2 will describe an exemplary process for product sourcing FIG. 2. Once a user places an order for a delivery (201), or once an order is created, the present disclosure initiates a process of fulfilling the products required for delivery (202). In an embodiment, it can be any ordering platform where a user places an order for delivery of the required products. It can be any supply chain environment where a user requires products to be delivered to a particular location.

In an embodiment, the process of fulfilling the products, or sourcing of the products may be initiated (209). Initially the details of products to be delivered may be identified. This may include collating details related to the products such as, but not limited to, a product identifier, requested quantity for each product, and the selling price. Each unit of the product may have a unique product identifier. It may be in any user required format. Each product identifier may include the selling price.

In an embodiment, each order may have an associated delivery service level. The user may choose the service level needed while creating an order. There may be multiple service levels, each including different category of services. Such category of service may include packaging, notifications, chosen time of delivery etc. Accordingly, while initiating a product sourcing, the service level may also be identified.

In an embodiment, while initiating the product sourcing, the ship-to location for each product is identified. This maybe in the form of a zip code, postal code or any other identifier for locations can be used as per the user requirements. In case the product identifiers, or location identifiers or other details are not provided in the required format, an error notification may be provided to the user. The user may then correct the details accordingly.

Once the details for the product and the ship-to location are validated, the fulfilling location for each product is identified. This may be done from a repository which may contain the available fulfilling locations for every product. There may be multiple fulfilling locations for every listed product in the repository. Each of the fulfilling locations for a product is selected.

In an embodiment, each fulfilling location may have an associated delivery network which includes the delivery location where the product can be delivered to, from that fulfilling location. Multiple delivery locations may be associated to the fulfilling locations based on distance between them, or resources required for the delivery or any other related parameters. Each product in an order may have separate fulfilling locations, or a group of products in an order may be fulfilled from one fulfilling location. The group of products may be related or unrelated.

In an embodiment, few of the identified fulfilling locations may be ignored. For instance, fulfilling locations that having insufficient inventory, or have insufficient capacity to fulfil may be ignored.

In an embodiment, various combinations of the products in an order are prepared. These combinations may imply the products that can be fulfilled from a single fulfilling location, together or single. For instance, if A, B and C are unique products requested in an order, it can result into 7 possible combination A, B, C, AB, AC, BC and ABC, of fulfilling the order. For each of these combinations of products the suitable fulfilling locations are identified, and it can be visualized in the form of a matrix.

In an embodiment once the fulfilling location and delivery locations for each combination of products are identified, the latest values of some parameters related to the fulfilling locations are fetched. These parameters may be dynamic and their value may be keep updating as per the user and the implementation requirements. In an example sell through rate may be a dynamic parameter. Anytime an order sourcing is initiated the latest value of the sell through rate is used, for the order processing. In another embodiment, the markdown may be a dynamic parameter. The latest value of the markdown parameter is used while initiating an order sourcing. Similarly, many other parameters may be used in order sourcing. Similarly, many other parameters may be dynamic. This may provide optimal selection of parameter values and product sourcing, at run time. It will not be a static sourcing of a product.

In one embodiment, the markdown value may be identified as,

$$\left(\left(\text{Price paid}\right) \text{-} \left(\text{Markdown Price at Node}\right) * \text{Quantity}\right) * \text{Ranking index}$$

where price paid is the selling price paid by a customer while placing the order;
markdown price is the reduction provided by the user; and
ranking index is the index allocated by a user for markdown price.

Similarly value of other parameters may be identified using their ranking index appropriately.

For instance a user may choose to identify value of ATP as,

$$\text{Ranking*} \left(\text{Requested Quantity}\right) / \left(\text{Available Quantity}\right)$$

In an embodiment, each of the parameters related to a fulfilling location, may have an impact on the product sourcing. In an example some parameters may have a positive impact on the product sourcing. In one embodiment, positive impact may include an impact on cost such that the seller may get a good cost; an impact on delivery time such that the delivery is smoother; an impact on quality of the product such that a better-quality product can be delivered and other similar positive impacts. In an example some parameters may have a negative impact on the product sourcing. In one embodiment, negative impact may include loss for the seller, delayed delivery, delayed fulfilment, and other similar negative impacts.

In one embodiment, the net benefit cost for each product is calculated using the parameters related to the fulfilling location for each product (203-208). The net benefit may be calculated by finding the difference between all the positive impact parameters, and all the negative impact parameters. For instance, the below equation maybe used to calculate the net benefit,

$$\begin{matrix}\text{Net Benefit = Markdown Value + ATP Value + Node Value} \text{−} \left(\text{Labor Value +}\right) \\ \left(\text{Shipping Cost Value +} \text{} \text{Transit Value}\right)\end{matrix}$$

In another embodiment the net benefit maybe calculated by the difference between cost generating parameters and cost incurring parameters. Cost generating parameters maybe termed as positive impact parameters, and cost incurring parameters maybe termed as negative impact parameters.

In an embodiment, once the net benefit is calculated, the constraints for a particular fulfilling location maybe considered (210). As an example, a constraint may be - requested quantity of the product must be fulfilled by a specific location only in full must be fulfilled by a specific location in full, no partial fulfilment allowed at order line level, or a particular amount should be fulfilled at a particular time, or from a particular fulfilling location. Order line may be defined as a sub level within an order, for e.g. order can have multiple order lines to fulfill. These constraints may be provided by the customer, or they may be provided by the user. Alternatively, the fulfilling locations may have their own required constraints. Accordingly, constraints may be applied by any participating entity.

In an embodiment, once the net benefit and the applicable constraints for each product combination are identified, they may be provided as an input to any optimization engine (211). The input may be provided in a form of a matrix. The optimization engine may provide the optimal sourcing option for the order, based on the inputs.

The output by the optimization engine maybe used to process the order (212) and deliver the products appropriately in an optimal way.

An embodiment of product sourcing in integration with an ordering platform, and the related data flow, will be explained along with the explanations of FIG. 3.

In an embodiment an ordering platform may receive orders from a system configured to capture or receive orders from a customer (304). The order capture system maybe any ecommerce platform, or a physical store which can take orders for product delivery. Alternatively, orders can also be placed through a catalog in a tele marketing option, or through a call center. There can also be any other type of order capture system that can provide product delivery to customers.

In an embodiment, a sourcing service engine (303.2) may be integrated in a computing environment. In an example, the computing environment maybe a runtime environment (303). The runtime environment may relate to an environment or a platform in which an application or a service is executed. It may include the hardware and software infrastructure and configurations necessary to implement product ordering services. In an example, the runtime environment may provide the engines, the compiler, server and other related resources. The runtime environment may be integrated with separate repositories distributed across multiple systems. These repositories may store with it, various parameters and the values needed for the present processing.

In an embodiment the runtime environment may comprise multiple networks of nodes, connected in an appropriate network topology. The network may also be connected to one or more order capturing devices or nodes, where a customer places an order, a network of delivery locations, or a network of fulfilling locations and other required nodes. These nodes may be distributed across various computing systems and connected to an ordering platform using communication interfaces, and appropriate networking gateways. In an embodiment, the ordering platform connected to the runtime environment may be hosted on a server system or a distributed server system.

In an embodiment, the runtime environment may also comprise of a sourcing optimizer engine (303.1). Any optimizer engine may be used in the runtime environment. The optimizer engine may help the ordering platform select an optimal way of sourcing the products from the inputs provided to it. The inputs to be provided to the optimizer engine may be configured and processed by the sourcing services engine (303.2). The sourcing engine may implement the sourcing process as explained earlier in explanation of FIG. 2.

In an embodiment, when the sourcing services engine (303.2) gets an order to be processed and sourced (302), it may fetch the values of the required parameters for each product in the order, from one or more repositories in one or more nodes of the runtime environment. The repository may also be integrated with the ordering platform. The repository may store the parameters, its value, ranking, and index for each product available with the ordering platform. The parameters may be decided by an admin of the ordering platform. The parameters may also be decided automatically based on the products. As discussed in earlier paragraphs, some parameters may have a dynamic value, and the latest value may be fetched for those parameters. This may enable optimal and dynamic sourcing and help avoid static sourcing. Alternatively, if a user or an ordering admin has manually updated the value of some parameters, as per the requirements, the sourcing process will automatically take the most updated or the latest value.

In one embodiment each parameter is provided a ranking. The ranking may be decided by an admin. It may be decided as per the admin on the basis of the impact created by a particular parameter on the net benefit cost, or the optimization of the fulfilment.

In an embodiment, all possible combinations of the products requested in an order are prepared. The ordering platform or the runtime environment may be configured to prepare the combinations. The value of the parameters for each of the product combinations maybe transmitted to the sourcing engine using communication means. Alternatively, the sourcing engine and the one or more repositories may be available within the same computing environment. These parameters may include one or more of available capacity to fulfil, transit time, shipping cost, labor cost, node value and other such parameters, as considered appropriate by the admin. The net benefit cost maybe calculated using the parameter values, the ranking, and the index.

In an embodiment, sell through rate along with markdown value can be the dynamic parameters. Alternatively, the admin can identify different set of parameters which can be dynamic. The dynamic parameters can be decided based on the set of users, set of products or the location or any other related factors.

In an embodiment the order can be captured or placed by a customer at any ordering store that can provide products to the ship-to location. Alternatively the order can be placed using phone call at a call centre, e-commerce platform, or from any catalog in a telemarketing platform. Any such platform that facilitates and enables placing an order can be used.

In an embodiment these transmitted parameter values, along with the calculated set of parameter values may be used as inputs for the sourcing optimizer engine. The sourcing optimizer engine may use any standard process or algorithm to provide one or more optimized sourcing as an output. In an embodiment, the runtime environment may then return the optimized sourcing options, as an output, to the ordering platform. The ordering platform may then send the sourcing output and place the order, or take it forward for fulfilment (304). For order fulfilment, the optimized sourcing options may be delivered to the required entities as appropriate such as the fulfilling locations.

The process of implementing an embodiment of the present disclosure will be elaborated using an example.

For instance, the following may be the parameters configured by an admin for an ordering platform.

| Sl No | Parameter | Details | Ranking |
|---|---|---|---|
| 1 | Markdown Value | ((Price paid)- (Markdown Price at Node)^{∗}Quantity)^{∗}Ranking^{∗}100 | 1 |
| 2. | Labor Value | Labor Cost^{∗}Ranking^{∗}100 Labor Cost -> Static value from Configuration table | 1 |
| 3 | Shipping Cost Value | Shipping Cost^{∗}Ranking^{∗} 100 Shipping Cost-> Value for each store in Store Table | 1 |
| 4 | Transit Value | 1-(Transit Index) Transit time on Node/Transit time on Order | 2 |
| 5 | ATP Value | 1-(Total Weight = Input Weight* Quantity)/Available Quantity (Defaulted 10) | 3 |
| 6 | Node Value | (Remaining Capacity/Total Availability)^{∗}100^{∗}Ranking | 4 |

In this example, the Net Benefit maybe calculated by,

$$\begin{matrix}\left[\text{Markdown Value - Labor Value - Shipping Cost Value -} \text{} \text{Transit Value}\right] + \text{ATP} \\ \text{Value +} \text{} \text{Node Value}\end{matrix}$$

The ranking index configured by the admin may be
1 = 0.01
2 = 0.0001
3 = 0.000001
4 = 0.00000001

If there are two store nodes considered and one product is ordered, the following may be the processing done. For the purpose of this example, some values have been assumed for labor cost, shipping cost, transit time and other such parameters.

| Sl No | Parameter | Details | Ranking | Values for Node 1 | Values for Node 2 |
|---|---|---|---|---|---|
| 1 | Markdown Value | ((Price paid)-(Markdown Price at Node)^{∗} Quantity) ^{∗}Ranking^{∗}100 | 1 | $22 | $20 |
| 2. | Labor Value | Labor Cost*Ranking^{∗}100 Labor Cost -> Static value from Configuration table | 1 | $1.7 | $1.7 |
| 3 | Shipping Cost Value | Shipping Cost^{∗}Ranking^{∗}100 Shipping Cost-> Value for each store in Store Table | 1 | $10 | $5 |
| 4 | Transit Value | 1-(Transit Index) Transit time on Node/Transit time on Order | 2 | 0.9999 | 0.9998 |
| 5 | ATP Value | Ranking^{∗}(Requested Quantity)/(Available Quantity)^{∗}100 | 3 | 0.00002 | 0.00001 |
| 6 | Node Value | (Remaining Capacity/Total Availability)^{∗}100 ^{∗}Ranking | 4 | 0.0000002 | 0.0000001 |
| | | Net Benefits [Markdown Value -Labor Value -Shipping Cost Value - Transit Value] + ATP Value + Node Value | | $9.3001202 | $12.3002101 |

As per the above example, the optimizer will recommend Node 2 as net benefits are exceeding against Node 1.

FIG. 4 provides a sample matrix prepared in case of multiple products being ordered. The net benefit identified for each product combination is provided in the matrix, against each fulfilling option. In the figure the rows represent the product combinations that can be fulfilled from one fulfilling location. The columns represent the fulfilling locations available. This matrix may be prepared using the parameter values for each product, as described in the earlier paragraphs. It may be provided as an input to the optimization engine. The optimization engine may analyze each net benefit costs mentioned there, for each fulfilling center and each combination of products. It may use any standard algorithm to identify an optimal combination for sourcing of the products. The sample matrix illustrates an example having four unique products and twelve unique fulfilment locations.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for product sourcing, comprising:
fetching one or more fulfilling locations for each combination of one or more products required at a ship-to location;
verifying if one or more delivery locations associated with the fetched fulfilling locations, include the ship-to location for each of the combination;
calculating values for one or more parameters associated with each verified fulfilling location, and each of the parameters being one of a positive impact parameter, or a negative impact parameter;
calculating a net benefit cost for each of the combination and each verified fulfilling location, using the calculated values of the parameter; and
identifying an optimal combination of products for sourcing, from each of the combinations of products, based on one or more of, the net benefit cost and one or more constraints for the products.

2. The method as claimed in claim 1, further comprising identifying product details for each of the required products, the product details comprising:
a product identifier;
a required quantity of the product;
a selling price of the product;
a level of delivery service; and
the ship-to location.

3. The method as claimed in claim 1, wherein the fulfilling location can be same for more than one combination of products.

4. The method as claimed in claim 2, wherein the parameters comprise one or more of:
inventory;
sell-through rate;
available fulfilling capacity;
transit time;
shipping cost;
labor cost; or
node value;
wherein a value of the parameters is calculated for each of the combination of the products and each fulfilling location, using a ranking for each of the parameters.

5. The method as claimed in claim 4, wherein the calculating the net benefit comprises:
fetching the ranking of the one or more parameters; and
calculating a difference between values of the positive impact parameters, and the negative impact parameters.

6. The method as claimed in claim 5, wherein the identifying an optimal combination comprises:
providing the calculated net benefit, the product details, and the one or more constraints, for each of the combination of the product and each fulfilling location, as input to an optimization engine; and
receiving an optimized fulfilling location and combinations of product, as an output from the optimization engine.

7. A system for product sourcing comprising a processor and a memory comprising instructions executable by the processor to cause the system to perform operations comprising:
fetching one or more fulfilling locations for each combination of one or more products required at a ship-to location;
verifying if one or more delivery locations associated with the fetched fulfilling locations, include the ship-to location for each of the combination;
calculating values for one or more parameters associated with each verified fulfilling location, and each of the parameters being one of a positive impact parameter, or a negative impact parameter;
calculating a net benefit cost for each of the combination and each verified fulfilling location, using the calculated values of the parameter; and
identifying an optimal combination of products for sourcing, from each of the combinations of products, based on one or more of, the net benefit cost and one or more constraints for the products.

8. The system as claimed in claim 7, further comprising:
identifying product details for each of the required products, the product details comprising:
a product identifier;
a required quantity of the product;
a selling price of the product;
a level of delivery service; and
the ship-to location.

9. The system as claimed in claim 7, wherein the fulfilling location can be same for more than one combination of products.

10. The system as claimed in claim 8, wherein the parameters comprise one or more of:
inventory;
sell-through rate;
available fulfilling capacity;
transit time;
shipping cost;
labor cost; or
node value;
wherein value of the parameters is calculated for each of the combination of the products and each fulfilling location, using a ranking for each of the parameters.

11. The system as claimed in claim 10, wherein the operation comprises calculating the net benefit by,
fetching the ranking of the one or more parameters; and
calculating a difference between values of the positive impact parameters, and the negative impact parameters.

12. The system as claimed in claim 11, further comprising identifying an optimal combination by:
providing the calculated net benefit, the product details, and the one or more constraints, for each of the combination of the product and each fulfilling location, as input to an optimization engine; and
receiving an optimized fulfilling location and combinations of product, as an output from the optimization engine.

13. A non-transitory computer readable medium with instructions stored thereon that, when executed by a processor, cause the processor to perform operations comprising:
fetching one or more fulfilling locations for each combination of one or more products required at a ship-to location;
verifying if one or more delivery locations associated with the fetched fulfilling locations, include the ship-to location for each of the combination;
calculating values for one or more parameters associated with each verified fulfilling location, and each of the parameters being one of a positive impact parameter, or a negative impact parameter;
calculating a net benefit cost for each of the combination and each verified fulfilling location, using the calculated values of the parameter; and
identifying an optimal combination of products for sourcing, from each of the combinations of products, based on one or more of, the net benefit cost and one or more constraints for the products.

14. The computer readable medium as claimed in claim 13, further comprising identifying product details for each of the required products, the product details comprising:
a product identifier;
a required quantity of the product;
a selling price of the product;
a level of delivery service; and
the ship-to location.

15. The computer readable medium as claimed in claim 13, wherein the fulfilling location can be same for more than one combination of products.

16. The computer readable medium as claimed in claim 14, wherein the parameters comprise one or more of:
inventory;
sell-through rate;
available fulfilling capacity;
transit time;
shipping cost;
labor cost; or
node value;
wherein a value of the parameters is calculated for each of the combination of the products and each fulfilling location, using a ranking for each of the parameters.

17. The computer readable medium as claimed in claim 16, wherein the calculating the net benefit further comprises:
fetching the ranking of the one or more parameters; and
calculating a difference between values of the positive impact parameters, and the negative impact parameters.

18. The computer readable medium as claimed in claim 17, wherein the identifying an optimal combination further comprises:
providing the calculated net benefit, the product details, and the one or more constraints, for each of the combination of the product and each fulfilling location, as input to an optimization engine; and
receiving an optimized fulfilling location and combinations of product, as an output from the optimization engine.
